(19) United States
(12) Patent Application Publication
(10) Pub. No.: US 2006/0067510 A1
(43) Pub. Date: Mar. 30, 2006

(54) Telephone tone setting system and method

(75) Inventors: Zhu-Min Di, Shanghai City (TW); Tony Tsai, Hsinchu (TW); David Ho, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 10/930,861

(22) Filed: Sep. 1, 2004

(51) Int. Cl. H04M 3/00

(52) U.S. Cl. 379/386

(57) ABSTRACT

A telephone tone setting system and method allows a speaker to set the tone of a receiver. The system includes an authorization control module, a setting module, a receiving module, a number comparing and judging module and an audio broadcasting module. The authorization control module is located in the receiver to control acceptance of tone setting from the speaker. The setting module is located in the speaker for setting the tone of the receiver and mating the phone number of the speaker and the corresponding tone. The receiving module detects and receives the phone number of a phone connecting to the receiver. The number comparing and judging module compares and determines whether the detected phone number matching the phone number of the speaker. When the phone numbers match, the audio broadcasting module broadcasts in the receiver the tone corresponding to the phone number of the speaker.

### FIELD OF THE INVENTION

The present invention relates to a telephone tone setting system and method and particularly to a system and method that allows one telephone to set the tone of another telephone.

### BACKGROUND OF THE INVENTION

Mobile phones are very popular nowadays. In order to increase the added value of the mobile phones and improve the appealing, many personalized designs for mobile phones have been developed. The personalized design mainly focuses on two areas: style and special telephone tone.

The design of telephone tone mostly addresses the improvement of the tone music. In the conventional techniques, setting the telephone tone can only be done on user's own mobile phone. Besides editing the telephone tone, it is also possible to set an edited tone to mate a corresponding phone number. When an incoming call arrives (the mobile phone is connected), a corresponding tone is broadcast according to the set phone number so that user can quickly identify the caller by hearing the tone.

However, the conventional techniques only allow the mobile phone user to set the tone. This function is widely available and cannot increase the added value of the mobile phone very much.

### SUMMARY OF THE INVENTION

Therefore the primary object of the invention is to provide a telephone tone setting system and method to increase the added value of mobile phones. The system and method according to the invention can set the telephone tone of one telephone from another telephone. In addition to enable a phone user to identify the caller, he/she also can edit and set the tone of another phone. It gives user more satisfaction and a sense of privilege. Phone user can hear the unexpected tone with amusement and pleasant surprise. Hence it provides a greater added value for the phone.

Another object of the invention is to provide a telephone tone setting system and method that can set the tone of one telephone from another telephone. The user of another telephone can transmit the edited tone to convey feeling such as happy, angry, sad, joy and the like to the phone user.

The telephone tone setting system and method according to the invention allows a speaker to set the tone of a receiver. The tone setting system includes an authorization control module, a setting module, a receiving module, a number comparing and judging module and an audio broadcasting module. The authorization control module is located in the receiver to control acceptance of tone setting of the receiver from the speaker. The setting module is located in the speaker for setting the tone of the receiver after the communication link between the speaker and the receiver has been established, and mating the phone number of the speaker to the corresponding tone, and storing the setting in a memory of the receiver.

The receiving module is located in the receiver to detect and receive the phone number of a phone connected to the communication link. The number comparing and judging module is located in the receiver to compare and match the detected phone number on the communication link with the phone number of the speaker. The audio broadcasting module is located in the receiver to broadcast the tone corresponding to the speaker set by the setting module when the detected phone number matches the phone number of the speaker.

Thus by means of the invention, another telephone (speaker) can set the tone of one telephone (receiver). Besides allowing the phone user to identify the caller, he/she also can edit the tone of another phone. This gives the phone user more satisfaction. Phone user can hear the unexpected tone with amusement and pleasant surprise, and another phone user can convey the feeling such as happy, angry, sad, joy and the like to the phone user. It meets the requirements of humanized design, and increases the added value of mobile phone.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1a is a schematic view of the telephone tone setting system of the invention.

FIG. 1b is a flow chart of the telephone tone setting method of the invention.

FIG. 2a is a schematic view of a first embodiment for editing the telephone tone of the invention.

FIG. 2b is a flow chart of the first embodiment for editing the telephone tone of the invention.

FIG. 3a is a schematic view of a second embodiment for editing the telephone tone of the invention.

FIG. 3b is a flow chart of the second embodiment for editing the telephone tone of the invention.

FIG. 4a is a schematic view of a third embodiment for editing the telephone tone of the invention.

FIG. 4b is a flow chart of the third embodiment for editing the telephone tone of the invention.

FIG. 5a is a schematic view of a fourth embodiment for editing the telephone tone of the invention.

FIG. 5b is a flow chart of the fourth embodiment for editing the telephone tone of the invention.

### DESCRIPTION OF THE PREFERRED EMBODIMENTS

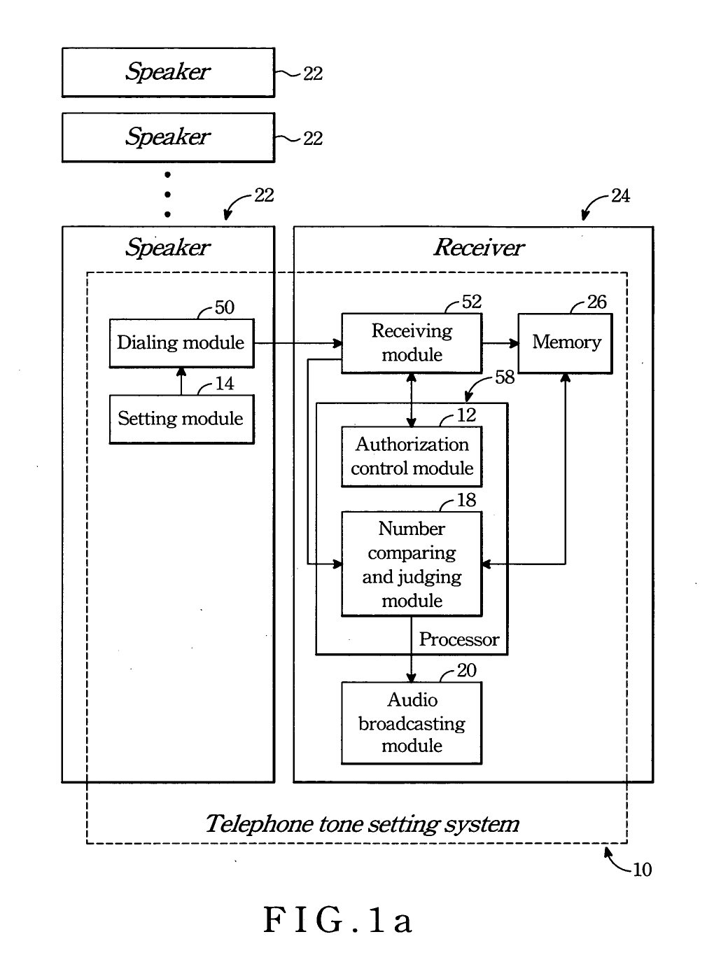

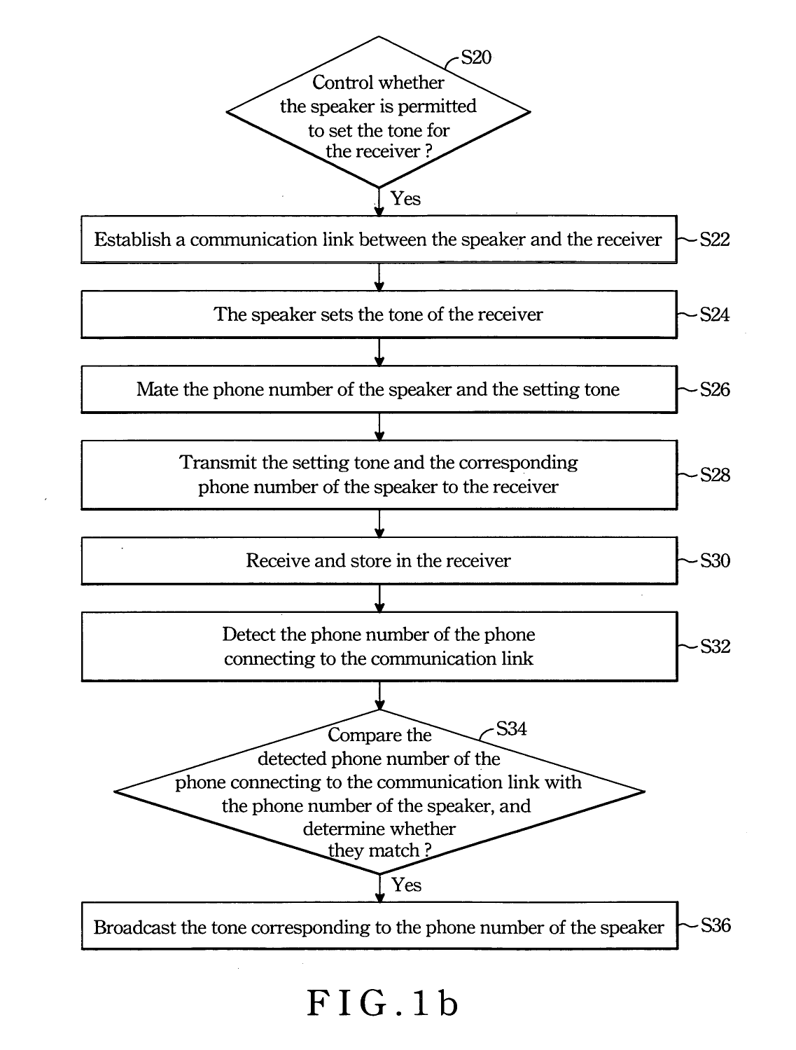

Refer to FIG. 1a for a telephone tone setting system 10 of the invention. It includes a setting module 14 and a dialing module 50 that are located in a speaker 22, and an authorization control module 12, a receiving module 52, a processor 58, a number comparing and judging module 18, a memory module 26 and an audio broadcasting module 20 that are located in a receiver 24.

The setting module 14, after the speaker 22 has established a communication link with the receive 24 through the dialing module 50 and the receiving module 52, and has been approved by the authorization control module 12, can set the tone of the receiver 24, and mate the phone number of the receiver 22 and the corresponding tone, and store the setting in the memory 26 of the receiver 24. The dialing module 50 aims to dial the number of the speaker 22 to establish the communication link. After dialing, the message of the dialed phone number of the speaker 22 also is issued.

The receiving module 52 aims to receive the tone of the receiver 24 set by the setting module 14 and the corresponding phone number of the speaker 22. It also receives and detects the phone number message issued by the phone connected to the communication link, and identifies the phone number. The processor 58 processes the tone of the receiver 24 set by the setting module 14 and the corresponding phone number of the speaker 22. The processor 58 includes the number comparing and judging module 18 and the authorization control module 12.

The authorization control module 12 aims to control authorization that permits the speaker 22 to set tone for the receiver 24. The number comparing and judging module 18 compares the phone number detected by the receiving module 52 with the phone number of the speaker 22 connected to the communication link, and determines whether they match. The audio broadcasting module 20 broadcasts the tone set by the setting module 14 corresponding to the phone number of the speaker 22 when the detected phone number matches the phone number of the speaker 22. When the memory 26 has stored more preset telephone tones and the corresponding phone numbers, the benefit of the invention increases.

Refer to FIG. 1b for the process flow of the method for setting telephone tone. It includes the following procedures: on the receiver 24, control whether the speaker 22 is permitted to set the tone for the receiver 24 (step S20); establish a communication link between the speaker 22 and the receiver 24 (step S22); in the condition of the receiver 24 accepts tone setting from the speaker 22, the speaker 22 sets the tone of the receiver 24 (step S24); mate the phone number of the speaker 22 and the setting tone (step S26); transmit the setting tone and the corresponding phone number of the speaker 22 to the receiver 24 (step S28); receive and store the setting tone and the corresponding phone number of the speaker 22 received by the receiver 24 in the memory 26 of the receiver 24 (step S30); the receiver 24 continuously detects the phone number sent by the phones connecting to the communication link (step S32); the receiver 24 compares the detected phone number sent by the phones connecting to the communication link with the phone number of the speaker 22, and determines whether they match (step S34); the receiver 24 broadcasts the tone corresponding to the phone number of the speaker 22 when the receiver 24 has determined that the detected phone number and the phone number of the speaker 22 match (step S36).

Editing of the telephone tone of the invention is elaborated through the following embodiments:

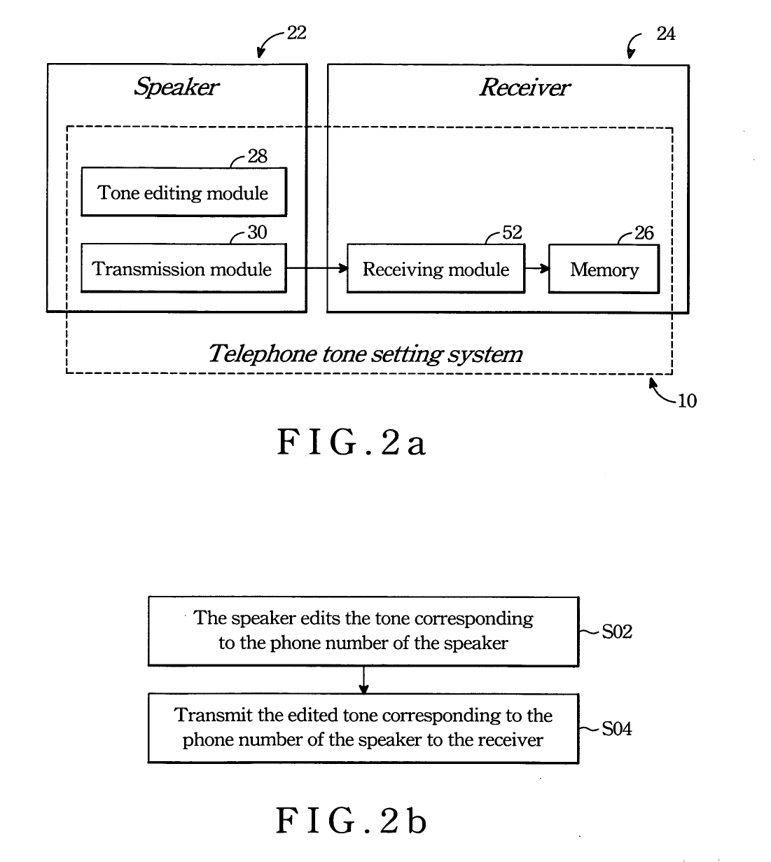

Refer to FIG. 2a for a first embodiment for editing the telephone tone of the invention. The telephone tone setting system 10 previously discussed further includes a tone editing module 28 and a transmission module 30 that are located in the speaker 22. The editing module 28 aims to edit the tone corresponding to the phone number of the receiver 22. The transmission module 30 transmits the edited tone corresponding to the phone number of the speaker 22 to the receiver 24. The receiving module 52 of the receiver 24 receives the edited tone and stores in the memory 26 to be used in the follow on procedures shown in FIG. 1a.

Refer to FIG. 2b for the process flow of the first embodiment for editing the telephone tone of the invention. Referring to the editing of tone previously discussed in FIG. 2a, the tone editing method includes the following procedures: the speaker 22 edits the tone corresponding to the phone number of the speaker 22 (step S02); transmit the edited tone corresponding to the phone number of the speaker 22 to the memory 26 of the receiver 24 (step S04); proceed the follow on procedures shown in FIG. 1b.

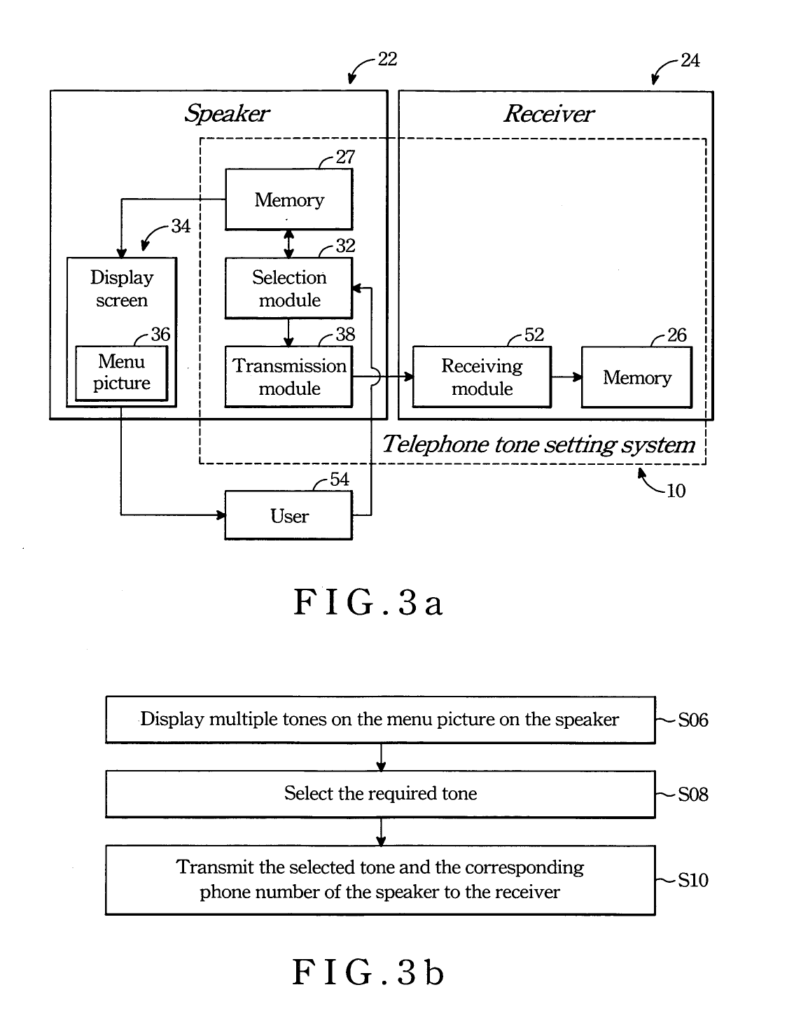

Refer to FIG. 3a for a second embodiment for editing the telephone tone of the invention. The telephone tone setting system 10 previously discussed may have a plurality of tones stored in advance in a memory 27 of the speaker 22. The telephone tone setting system 10 further includes a selection module 32 and a transmission module 38 that are located in the speaker 22. The selection module 32 allows a user 54 to select a required tone from a menu picture 36 on a display screen 34 of the speaker 22. The transmission module 38 transmits the selected tone and the corresponding phone number of the speaker 22 to the receiver 24. The receiving module 52 of the receiver 24 receives the edited tone corresponding to the phone number of the speaker 22 and stores in the memory 26 to be used in other functions and procedures shown in FIG. 1a.

Refer to FIG. 3b for the process flow of the second embodiment for editing the telephone tone of the invention. Referring to the editing of tone previously discussed in FIG. 3a, the tones may be stored in advance in the speaker 22. The tone editing method includes the following procedures: the display screen 34 of the speaker 22 displays the menu picture 36 containing a plurality of tones (step S06); select a required tone from the menu picture 36 (step S08); transmit the selected tone and the corresponding phone number of the speaker 22 to the memory 26 of the receiver 24 (step S10); proceed the follow on procedures shown in FIG. 1b.

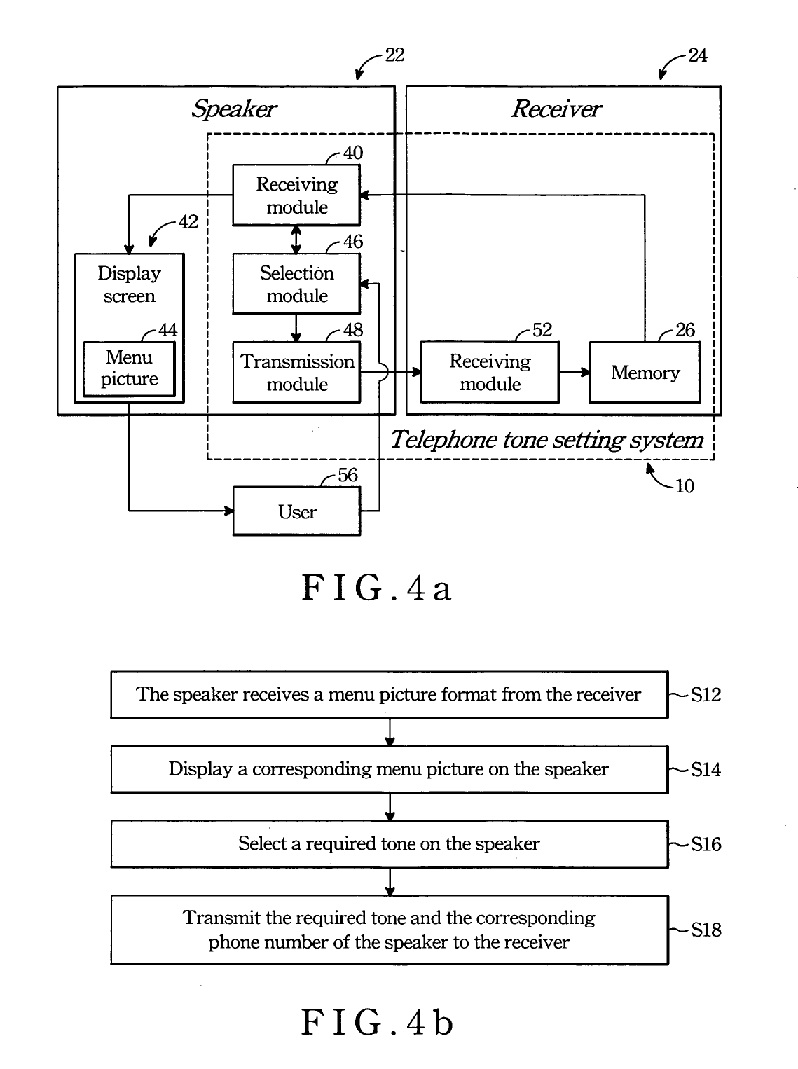

Refer to FIG. 4a for a third embodiment for editing the telephone tone of the invention. The telephone tone setting system 10 previously discussed may have a plurality of tones stored in advance in the memory 26 of the receiver 24 in a menu picture format. The telephone tone setting system 10 further includes a speaker receiving module 40, a selection module 32 and a transmission module 48 that are located in the speaker 22. The speaker receiving module 40 receives the menu picture format from the memory 26 of the receiver 24 after the communication link between the speaker 22 and the receiver 24 has been established, and displays a menu picture 44 corresponding to the menu picture format on a display screen 42 of the speaker 22. The selection module 46 allows a user 56 to select a required tone from the menu picture 44 on the display screen 42 of the speaker 22 to generate the required tone. The transmission module 48 transmits the required tone of the user 56 and the corresponding phone number of the speaker 22 from the speaker 22 to the receiver 24. The receiving module 52 of the receiver 24 receives the edited tone and stores in the memory 26 to be used in the other functions and procedures shown in FIG. 1a.

Refer to FIG. 4b for the process flow of the third embodiment for editing the telephone tone of the invention. Referring to the editing of tone previously discussed in FIG. 4a, the tones may be stored in advance in the memory 26 of the receiver 24 in a menu picture format. The tone editing method includes the following procedures: the receiver 22 receives the menu picture format from the memory 26 of the speaker 24 (step S12); display the menu picture 44 corresponding to the menu picture format on the display screen 42 of the speaker 22 (step S14); select a desired tone from the menu picture 44 on the speaker 22 to generate a tone message required by the user 56 (step S16); transmit the required tone message and the corresponding phone number of the speaker 22 to the memory 26 of the receiver 24 (step S18); proceed the follow on procedures shown in FIG. 1b.

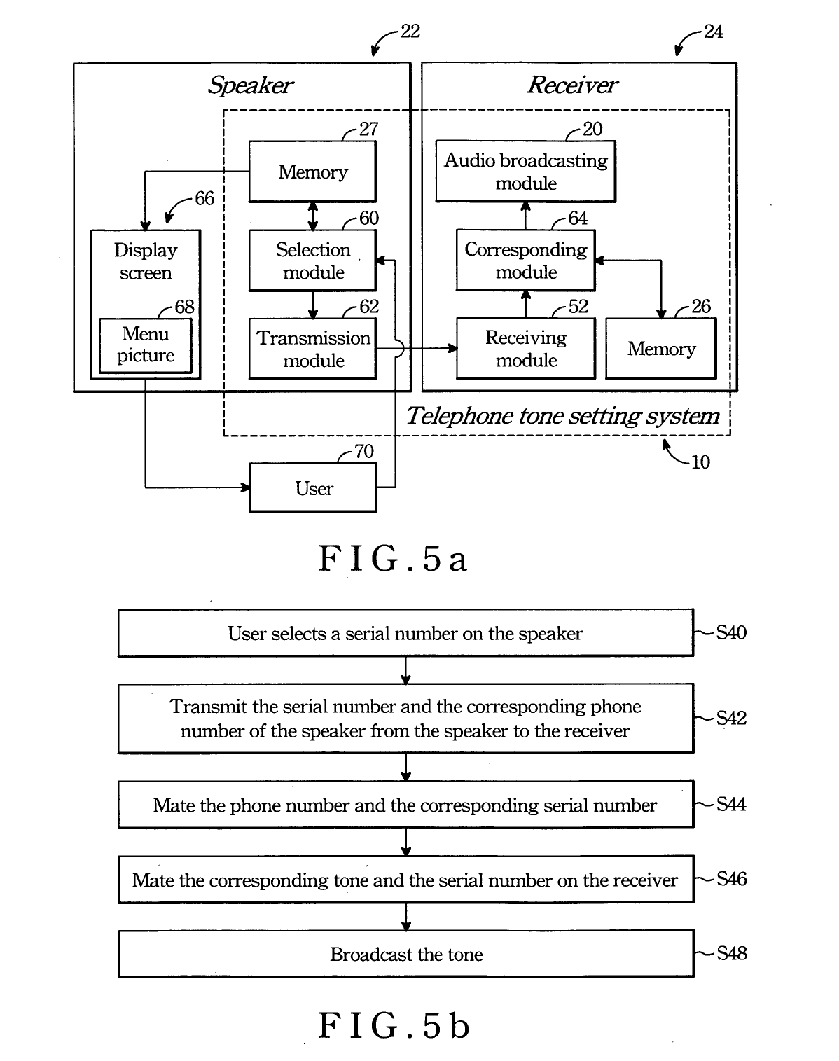

Refer to FIG. 5a for a fourth embodiment for editing the telephone tone of the invention. The telephone tone setting system 10 previously discussed may have a plurality of tones stored in advance in the memory 26 of the receiver 24 and the memory 27 of the speaker 22. Each tone corresponds to a serial number. The speaker 22 further includes a selection module 60 and a transmission module 62. The receiver 24 further includes a corresponding module 64.

The selection module 60 allows a user 70 to select a serial number from a menu picture 68 on a display screen 66 of the speaker 22 that corresponds to a tone. The transmission module 62 transmits the selected serial number and the phone number of the speaker 22 corresponding to the serial number to memory 26 of the receiver 24. The corresponding module 64 retrieves the tone from the memory 26 of the receiver 24 corresponding to the serial number after the receiving module 52 of the receiver 24 has received the phone number of a phone connecting to the communication link and broadcasts the sound through the broadcasting module 20.

Refer to FIG. 5b for the process flow of the fourth embodiment for editing the telephone tone of the invention. Referring to the editing of tone previously discussed in FIG. 5a, the tones may be stored in advance in the memory 26 of the receiver 24 and the memory 27 of the speaker 22. Each tone corresponds to a serial number. The tone editing method includes the following procedures:

A user 70 selects a serial number from the menu picture 68 on the display screen 66 of the speaker 22 (step S40); transmit the selected tone and the corresponding phone number of the speaker 22 to the memory 26 of the receiver 24 (step S42); after having received the phone number of a phone connecting to the communication link, match the phone number with the corresponding serial number (step S44); the corresponding module 64 matches the serial number and the corresponding tone stored in the memory 26 of the receiver 24 (step S46); the audio broadcasting module 20 broadcasts the tone (step S48).

Thus through the invention, another phone (speaker) can set the tone of a phone (receiver). Besides allowing the phone user to identify the caller, he/she also can edit and control the tone of another phone, and has greater satisfaction and a sense of privilege. Phone users can hear a unexpected tone with pleasant surprise. In addition, another phone user can edit the tone to convey his/her feeling such as happy, angry, sad and joy to the phone receiver. It is a more humanized design and has a greater added value.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A telephone tone setting system allowing a receiver to accept a tone setting by a speaker and receive the phone number of the speaker corresponding to the tone, comprising:
a receiving module located in the receiver to receive and detect a phone number of a phone connecting to a communication link;
a number comparing and judging module located in the receiver to compare the detected phone number of the phone connecting to the communication link and determine whether the phone number matching the phone number of the speaker; and
an audio broadcasting module located in the receiver to broadcast the tone corresponding to the phone number of the speaker when the phone number matches the phone number of the speaker.

2. The telephone tone setting system of claim 1, wherein the speaker includes a setting module to set the tone of the receiver after the communication link between the speaker and the receiver has been established, and match the phone number of the speaker and the tone and store the setting in the receiver.

3. The telephone tone setting system of claim 1 further including an authorization control module located in the receiver to control whether the receiver to accept the tone setting by the speaker.

4. The telephone tone setting system of claim 2, wherein the tone corresponding to the phone number of the speaker is stored in a memory of the receiver.

5. The telephone tone setting system of claim 4, wherein the speaker further includes:
a tone editing module to edit the tone corresponding to the phone number of the speaker; and
a transmission module to transmit the edited tone to the memory of the receiver.

6. The telephone tone setting system of claim 4, wherein the tones are stored in advance in the speaker which further includes:
a selection module allowing a user to select a required tone from a menu picture on a display screen located on the speaker; and
a transmission module to transmit the selected tone and the phone number corresponding to the tone to the memory of the receiver.

7. The telephone tone setting system of claim 4, wherein the tones are stored in advance in the memory of the receiver in a menu picture format, the speaker further including:
a speaker receiving module to receive the menu picture format after the communication link between the speaker and the receiver has been established, and display a menu picture corresponding to the menu picture format on a display screen of the speaker;
a selection module allowing a user to select a tone from the menu picture on the display screen of the speaker to generate a required tone message; and
a transmission module to transmit the required tone message and the corresponding phone number of the speaker from the speaker to the memory of the receiver.

8. The telephone tone setting system of claim 4, wherein the tones are stored in advance in the memory of the receiver and a memory of the speaker corresponding respectively to a serial number, the speaker further including:
a selection module allowing a user to select the serial number from a menu picture on a display screen of the speaker corresponding to the tone; and
a transmission module to transmit the selected serial number of the tone and the phone number of the speaker corresponding to the serial number to the memory of the receiver.

9. The telephone tone setting system of claim 8, wherein the receiver further includes:
a corresponding module to retrieve the tone corresponding to the serial number of the phone from the memory of the receiver and broadcast the tone through the audio broadcasting module after the receiving module of the receiver having received the phone number of the phone connecting to the communication link.

10. A method for setting telephone tone allowing a receiver to receive and store a tone set by a speaker and the phone number of the speaker corresponding to the tone, comprising the steps of:
establishing a communication link between the speaker and the receiver;
receiving the tone and the phone number of the speaker corresponding to the tone by the receiver;
storing the tone and the phone number of the speaker corresponding to the tone in the receiver;
detecting the phone number of the phone connecting to the communication link by the receiver;
comparing the detected phone number and comparing the detected phone number with the phone number of the speaker to determine whether the detected phone number matching the phone number of the speaker by the receiver; and
broadcasting the tone corresponding to the phone number of the speaker in the receiver after the detected phone number has matched the phone number of the speaker.

11. The method of claim 10 further including the steps of:
setting the tone of the receiver from the speaker;
mating the phone number of the speaker and the tone; and
transmitting the tone and the mated phone number of the speaker to the receiver.

12. The method of claim 10 further including the step of controlling in the receiver whether to accept the tone setting by the speaker for the receiver.

13. The method of claim 10, wherein the tone corresponding to the phone number of the speaker is stored in a memory of the receiver.

14. The method of claim 10 further including the steps of:
editing the tone corresponding to the phone number of the speaker in the speaker; and
transmitting the tone corresponding to the phone number of the speaker to a memory of the receiver.

15. The method of claim 10, wherein the tones are stored in advance in the speaker, the method further including the steps of:
displaying a menu picture of the tones on a display screen on the speaker;
selecting a required tone from the menu picture; and
transmitting the required tone and the corresponding phone number of the speaker to a memory of the receiver.

16. The method of claim 10, wherein the tones are stored in advance in a memory of the receiver in a menu picture format, the method further including the steps of:
receiving the menu picture format by the speaker;
displaying a menu picture corresponding to the menu picture format on a display screen of the speaker;
selecting the tone from the menu picture on the speaker to generate a required tone message; and
transmitting the required tone message and the corresponding phone number of the speaker from the speaker to the memory of the receiver.

17. The method of claim 10, wherein the tones are stored in advance in a memory of the receiver and a memory of the speaker corresponding respectively to a serial number, the method further including the steps of:
selecting the serial number from a menu picture on a display screen of the speaker;
transmitting the selected serial number of the tone and the corresponding phone number of the speaker to the memory of the receiver;
mating the phone number and the serial number corresponding to the phone number after having received the phone number of a phone connected to the communication link; and
broadcasting the tone.
